(19) United States
(12) Patent Application Publication
(10) Pub. No.: US 2025/0178678 A1
(43) Pub. Date: Jun. 5, 2025

(54) DEFORMABLE SUPPORT WHEEL WITH RESILIENT CHAMBER AND TRACK SYSTEM HAVING SAME

(71) Applicant: SOUCY INTERNATIONAL INC., Drummondville (CA)

(72) Inventors: Etienne LEBLANC, Becancour (CA); Francois LAFLAMME, St-Germain-De-Grantham (CA); Patrice de MARTIN, Saint-Colomban (CA)

(21) Appl. No.: 18/960,737

(22) Filed: Nov. 26, 2024

Related U.S. Application Data
(60) Provisional application No. 63/605,133, filed on Dec. 1, 2023.

(51) Int. Cl. B62D 55/096; B62D 55/065; B62D 55/14

(52) U.S. Cl. CPC B62D 55/0966; B62D 55/14; B62D 55/065

(57) ABSTRACT

A deformable support wheel with a resilient chamber for a vehicular track-based system, is presented. The track-based support wheel comprises a central hub aperture portion configured to receive and operatively connect to a corresponding axle; a sidewall portion configured to concentrically surround an outer peripheral surface of the central hub aperture portion, the sidewall portion comprising a pair of radially-extending flanges that are laterally spaced apart from each other; and a deformable tire portion concentrically mounted on the sidewall portion. The inner surface of the flanges and an outer peripheral surface of the sidewall portion define a resilient chamber that provides a spacing between the outer peripheral surface of the sidewall portion and an inner peripheral surface of the tire portion. The support wheel structure minimizes lateral deformations caused by compression/shearing forces experienced during challenging environmental conditions by redirecting the deformations radially inward towards the resilient chamber.

### CROSS-REFERENCE TO RELATED APPLICATIONS

The present application claims benefits of and priority to U.S. Provisional Application No. 63/605,133, filed on Dec. 1, 2023, the entirety of which is incorporated herein by reference.

### FIELD OF TECHNOLOGY

The present technology generally relates to support wheels for track systems and, in particular, to deformable support wheels of track-based systems.

### BACKGROUND

Certain vehicles are specifically designed to operate in mud, snow, ice, or other challenging terrain, such as, for example, recreational vehicles, agricultural vehicles, industrial vehicles, military vehicles, exploratory vehicles, robotics vehicles, etc. Such vehicles are typically equipped with track-based systems that incorporate an endless ground-engaging track belt with externally-protruding gripping treads to enable vehicular travel over challenging terrain.

These track-based systems employ supporting wheels, such as, for example, mid-roller wheels configured to engage the ground and maintain proper width alignment of the endless track belt relative to the direction of travel. Other supportive wheels include idler wheels configured to maintain proper tension and stretched displacement of the endless track belt.

For certain field applications, track supporting wheels comprising non-pneumatic, deformable tire materials provide certain advantages. For example, unlike pneumatic wheels, non-pneumatic wheels do not require maintaining proper inflation pressures, are not susceptible to tire puncture issues, and have shown to provide improved durability/reliability in challenging terrain.

However, during travel over large obstacles or substantially uneven surfaces, these non-pneumatic, deformable resilient support wheels may be susceptible to severe compression levels that result in outer tire surfaces of the support wheels bulging, side-shifting or “bottoming” out. Continued travel of support wheels in these bulging or bottom-out states may significantly contribute to a variety of issues, such as, for example, width misalignment or de-tracking of the endless track belt, cause bulging rim portions to come into contact with drive lugs resulting in premature wear of the drive lugs of the track system, the wheels, and/or the endless track belt, etc.

As such, there appears to be a deficiency in the conventional arts with regard to issues associated with deformable support wheels experiencing bulging, side-shifting or bottom out states.

### SUMMARY OF TECHNOLOGY

It is an object of the present technology to ameliorate at least some of the deficiencies present in the conventional art.

According to one aspect of the present technology, a wheel for a vehicular track-based system is disclosed. The wheel includes a central hub aperture portion, a sidewall portion and a deformable tire portion. The central hub aperture portion is configured to receive and operatively connect to a corresponding axle. The sidewall portion is configured to concentrically surround an outer peripheral surface of the central hub aperture portion, and includes a pair of radially-extending flanges that are laterally spaced apart from each other. The deformable tire portion is concentrically mounted on the sidewall portion. An inner surface of the flanges and an outer peripheral surface of the sidewall portion define a resilient chamber that provides a spacing between the outer peripheral surface of the sidewall portion and an inner peripheral surface of the tire portion.

In some embodiments, the resilient chamber controllably directs a deformation of the tire portion radially inward towards the spacing of the resilient chamber.

In some embodiments, at least one of the outer peripheral surface of the sidewall portion and an inner peripheral surface of the tire portion defines at least one boundary of the chamber that has a concave shape.

In some embodiments, the deformable tire portion comprises a non-pneumatic tire made of a resilient material.

In some embodiments, the resilient material of the non-pneumatic tire comprises an elastomeric or polymeric material compound.

In some embodiments, the radially-extending flanges have a straight linear profile.

In some embodiments, the radially-extending flanges have an inwardly curved profile.

In some embodiments, the radially-extending flanges have an outwardly curved profile.

In some embodiments, the radially-extending flanges have an inwardly slanted profile.

In some embodiments, the radially-extending flanges have an outwardly slanted profile.

In some embodiments, the central hub aperture portion and sidewall portion are securely attached to each other via fasteners.

In some embodiments, the central hub aperture portion and sidewall portion are integrally formed.

In some embodiments, the wheel is an idler wheel.

In some embodiments, the wheel is a mid-roller wheel.

In some embodiments, the resilient chamber further comprises an access device configured to increase, decrease, or adjust a volume of fluid within the space defined by the chamber.

In some embodiments, the deformable tire portion has a width, and a contact surface interfacing with an inner surface of an endless track. The contact surface has a contact length. With the deformable tire portion in an undeformed state, the contact length is smaller than the width. With the deformable tire portion in a deformed state, the contact length increases to be greater than the width.

In some embodiments, the spacing varies from a first radial dimension when the deformable tire portion is in the undeformed state to a second radial dimension when the deformable tire portion is in the deformed state, in which the second radial dimension is smaller than the first radial dimension.

In some embodiments, the second radial dimension is null when the deformable tire portion is fully compressed.

In some embodiments, the wheel has a width defining an undeformed lateral footprint when the deformable tire portion is in an undeformed state and a deformed lateral footprint when the deformable tire portion is in a deformed state, the deformed lateral footprint being equal to the undeformed lateral footprint.

In some embodiments, at least one of the hub peripheral surface, the inner surface of the radially-extending flanges, and an inner surface of the deformable tire portion has a concave profile.

In some embodiments, the resilient material of the non-pneumatic tire provides different gradient levels of resiliency to accommodate various degrees of compressional states. In an undeformed state, the tire portion provides a first level of radial resiliency while in a completely deformed state, the tire portion provides a second level radial resiliency that is greater than the first radial level of resiliency.

In some embodiments, in response to deformable tire portion deforming, the radially-extending flanges are configured to confine and prevent lateral deformation of the deformable tire portion.

According to another aspect of the present technology, there is provided a track-based vehicle including a drive wheel assembly, an endless track belt, and a wheel according to the above aspect or according to the above aspect and one or more of the above embodiments. The drive wheel assembly is configured to provide a driving force. The endless track belt, which is operatively coupled to the drive wheel assembly, is configured to actuate vehicle movement in accordance with the driving force. The wheel engagedly supports the endless track belt. According to another aspect of the present technology, there is provided a wheel for a track system. The wheel includes a hub portion, a sidewall portion, and a deformable tire portion. The hub portion has a hub peripheral surface and a hub aperture configured to receive and operatively connect to an axle. The sidewall portion includes first and second radially-extending flanges laterally spaced apart from each other. The deformable tire portion is connected to the first and second radially-extending flanges, having an outer surface configured to engage with an inner surface of an endless track of the track system and an inner surface radially distant from the peripheral surface of the hub peripheral surface by a gap, the deformable tire portion being deformable between an undeformed state and a deformed state. The hub peripheral surface, the first and second radially-extending flanges and the inner surface of the deformable tire portion define a chamber configured to receive at least a portion of the deformable tire portion when the deformable tire portion is in the deformed state.

In some embodiments, the gap varies from a first gap when the deformable tire portion is in the undeformed state to a second gap when the deformable tire portion is in the deformed state.

In some embodiments, the first gap is greater than the second gap.

In some embodiments, the second gap is null when the deformable tire portion is fully compressed.

In some embodiments, the wheel is configured to provide a first radial resiliency when the deformable tire portion is in the undeformed state and a second radial resiliency different from the first radial resiliency when the deformable tire portion is in the deformed state.

In some embodiments, the deformed state is a first deformed state, and the wheel is further deformable to a second deformed state in which the wheel is configured to provide a third radial resiliency, the third radial resiliency being different from the first and second radial resiliencies.

In some embodiments, the deformable tire portion is at least partially confined by the radially-extending flanges.

In some embodiments, in response to the deformable tire portion deforming the connection between the deformable tire portion and the radially-extending flanges is configured to prevent lateral deformation of the deformable tire portion.

In some embodiments, the wheel has a width defining an undeformed lateral width when the deformable tire portion is in the undeformed state and a deformed lateral width when the deformable tire portion is in the deformed state, the deformed lateral width being equal to the undeformed lateral width.

In some embodiments, the deformable tire portion has a width, and a contact surface interfacing with an inner surface of an endless tack. The contact surface has a contact length. With the deformable tire portion in an undeformed state, the contact length is smaller than the width. With the deformable tire portion in a deformed state, the contact length increases to be greater than the width.

In some embodiments, the deformable tire portion has a lateral width in the undeformed state, the deformable tire portion retaining the lateral width when in deformed state.

In some embodiments, at least one of the hub peripheral surface, the inner surface of the radially-extending flanges and the inner surface of the deformable tire portion is concave.

According to another aspect of the present technology, there is provided a track system for a vehicle, the track system including a frame, a drive wheel assembly, a wheel according to the above aspect or according to the above aspect and one or more of the above embodiments, as well as an endless track. The drive wheel assembly is rotationally connected to the frame, and is configured to operatively connect to the vehicle. The wheel is rotationally connected to the frame. The endless track belt is operatively coupled to the drive wheel assembly.

According to another aspect of the present technology, there is provided a vehicle including a frame, a motor supported by the frame, and track systems according to the above aspect.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE FIGURES

For a better understanding of the present technology, as well as other aspects and further features thereof, reference is made to the following description which is to be used in conjunction with the accompanying drawings, where:

FIG. 1 illustrates a representative track-based vehicle, in accordance with the embodiments of the present technology;

FIG. 2 illustrates a representative track-based system, in accordance with the embodiments of the present technology;

FIG. 3A illustrates a front elevation view of a deformable support wheel with a resilient chamber, in accordance with the embodiments of the present technology;

FIG. 3B illustrates a cross-sectional perspective view of the deformable support wheel with a resilient chamber, in accordance with the embodiments of the present technology; and

FIG. 3C illustrates a cross-sectional view of the deformable support wheel with a resilient chamber, in accordance with the embodiments of the present technology; and

FIGS. 4A, 4B, 4C and 5 illustrate cross-sectional perspective views of the resilient chamber configuration, in accordance with the embodiments of the present technology.

### DETAILED DESCRIPTION

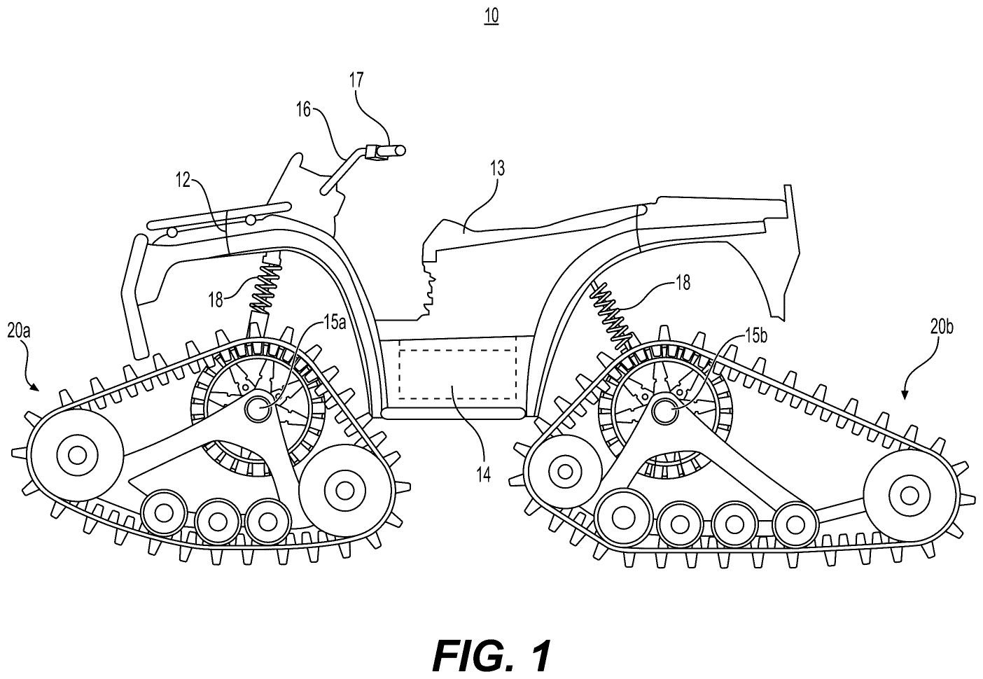

FIG. 1 illustrates a representative track-based vehicle 10, in accordance with the embodiments of the present technology. In the illustrated embodiment, the vehicle 10 is an off-road vehicle 10. More precisely, the vehicle 10 is an all-terrain vehicle (ATV) 10. It is contemplated that in other embodiments, the off-road vehicle 10 could be a snowmobile, a side-by-side vehicle (SSV), a utility-task vehicle (UTV) or another type of vehicle. The off-road vehicle 10 has four track systems in accordance with embodiments of the present technology, two front track systems 20a, and two rear track systems 20b. In some embodiments, the off-road vehicle 10 could have more or less than four track systems.

The off-road vehicle 10 includes a frame 12, a straddle seat 13 disposed on the frame 12, a powertrain 14 (shown schematically), a steering system 16, a suspension system 18, and the front and rear track systems 20a, 20b.

The powertrain 14, which is supported by the frame 12, is configured to generate power and transmit said power to the front and rear track systems 20a, 20b via driving axles, thereby driving the off-road vehicle 10. More precisely, the front track systems 20a are operatively connected to a front axle 15a and, the rear track systems 20b are operatively connected to a rear axle 15b, where the front and rear axles 15a, 15b are driven by the powertrain 14. It is contemplated that in some embodiments, the powertrain 14 could be configured to provide its motive power to only the front axle 15a or to only the rear axle 15b (i.e., in some embodiments, only one of the front axle 15a and/or rear axle 15b could be a driving axle). In some embodiments, the track systems 20a, 20b are operatively connected to non-driven axle of unpowered vehicles (e.g., trailer).

The steering system 16 is configured to enable an operator of the off-road vehicle 10 to steer the off-road vehicle 10. To this end, the steering system 16 includes a handlebar 17 that is operable by the operator to direct the off-road vehicle 10 along a desired course. In other embodiments, the handlebar 17 could be replaced by another steering device such as, for instance, a steering wheel. The steering system 16 is configured so that in response to the operator handling the handlebar 17, the orientation of the front track systems 20a is changed relative to the frame 12, thereby causing the off-road vehicle 10 to turn in a desired direction.

The suspension system 18, which is connected between the frame 12 and the track systems 20a, 20b allows relative motion between the frame 12 and the track systems 20a, 20b and can enhance handling of the off-road vehicle 10 by absorbing shocks and helping to maintain adequate traction between the track systems 20a, 20b and the ground.

The front and rear track systems 20a, 20b are configured to compensate for and/or otherwise adapt to the suspension system 18 of the off-road vehicle 10. For instance, the front and rear track systems 20a, 20b are configured to compensate for and/or otherwise adapt to alignment settings, namely camber (i.e., a camber angle, “roll”), caster (i.e., a caster angle, “steering angle”) and/or toe (i.e., a toe angle, “yaw”), which are implemented by the suspension system 18. As the off-road vehicle 10 was originally designed to use wheels instead of the front and rear track systems 20a, 20b, the alignment settings could originally have been set to optimize travel, handling, ride quality, etc. of the off-road vehicle 10 with the use of wheels. Since the track systems 20a, 20b are structurally different and behave differently from wheels, the track system 20a, 20b may be configured to compensate for and/or otherwise adapt to the alignment settings to enhance their traction and/or other aspects of their performances and/or uses.

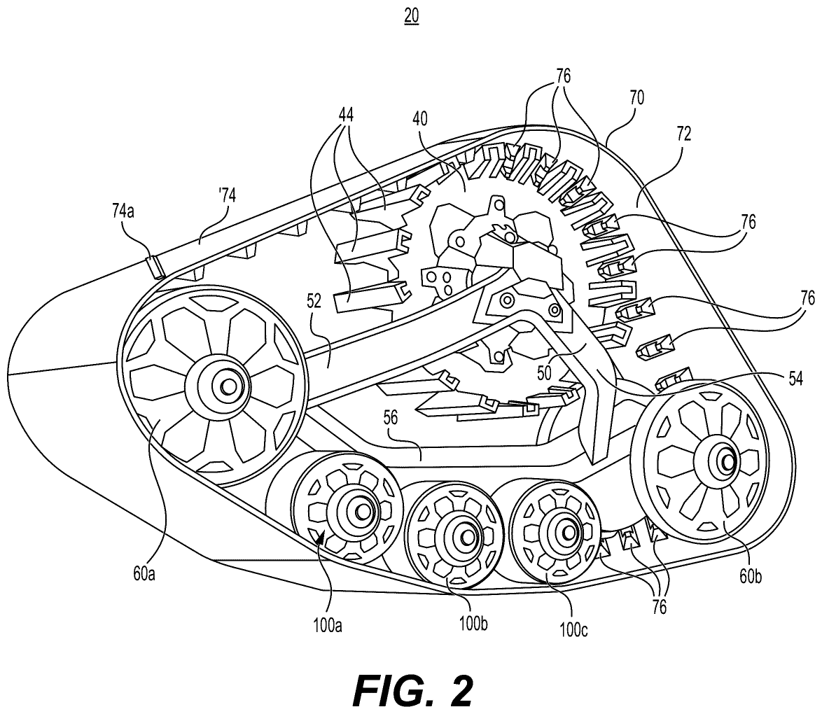

FIG. 2 illustrates a representative track-based system 20, in accordance with the embodiments of the present technology. It will be appreciated that, for the purposes of the present disclosure, the features of track-based system 20 are intended to be applicable, in whole or in part, to a variety of track-based vehicles such as, for example, all-terrain vehicles (ATVs), snowmobiles, side-by-side vehicles (SBSs), utility-task vehicle (UTVs), agricultural vehicles, industrial vehicles, military vehicles, exploratory vehicles, robotics vehicles, etc. Although the representative track-based system 20 described herein is generally similar to a front track system 20a, it is understood that the track-based system 20 is also representative of a rear track system 20b as well, or of any generally equivalent track system, and is in no way limited by this similarity.

As shown, track system 20 comprises an endless track belt 70 and a drive wheel assembly 40 that engages the track belt 70 and is operatively coupled to a driving axle (not shown). The endless track belt 70 extends around the various components of track system 20 and manifests an inner surface 72 and an outer surface 74. The outer surface 74 of the endless track belt 70 incorporates a plurality of externally-protruding gripping treads 74a (only one shown) along the span of the outer surface of the belt. And, as detailed below, the inner surface 72 of endless track 70 incorporates lugs 76 that are adapted to engage with the engaging members 44 of the drive wheel assembly 40. It will be appreciated that the endless track 70 may comprise elastomeric, polymeric, or any other compounds suitable for such purposes.

The drive wheel assembly 40 is driven by the driving axle, to thereby drive and actuate the track system 20 for movement. Thus, the drive wheel assembly 40 is configured to provide a driving force to the endless track belt 70. The drive wheel assembly 40 defines laterally extending engaging members 44 (i.e., teeth) disposed on the circumference of the drive wheel assembly 40. The engaging members 44 are adapted to engage with lugs 76 provided on an inner surface 72 of an endless track belt 70 of the track system 20. It is contemplated that in other embodiments, the configuration of the drive wheel assembly 40, and thus the manner in which the drive wheel assembly 40 engages the endless track 70, could differ without departing from the scope of the present technology.

The track system 20 further comprises a frame 50 that incorporates a leading frame member 52, a trailing frame member 54, and a lower frame member 56. The leading and trailing frame members 52, 54 are jointly connected around the driving axle, the joint connection being positioned laterally outwardly from the drive wheel assembly 40. The leading frame member 52 extends forwardly and downwardly from the joint connection and connects to a forward portion of the lower frame member 56. The trailing frame member 54 extends rearwardly and downwardly from the joint connection and connects to a rearward portion of the lower frame member 56. The lower frame member 56, which is positioned below the joint connection, extends generally parallel to the forward direction of travel of the vehicle.

In the depicted embodiment, the leading, trailing and lower frame members 52, 54, 56 are shown to be an integral unit. However, it is contemplated that in other embodiments, the leading, trailing and lower frame members 52, 54, 56 could be distinct members connected to one another. It is further contemplated that in other embodiments, the disclosed configuration of the frame 50 could differ without departing from the scope of the present technology.

With continued reference to FIG. 2, track system 20 further comprises support wheel assemblies, namely, leading idler wheel assembly 60a, trailing idler wheel assembly 60b, and a plurality of mid-roller wheel assemblies 100a, 100b, 100c. As noted above, the support wheel assemblies are configured to properly guide and maintain alignment of the endless track belt. In particular, the idler wheel assemblies 60a, 60b are generally configured to maintain proper tension of the endless track belt (e.g., via a tensioning system) while the mid-roller wheel assemblies 100a, 100b, 100c are generally configured to engage with the ground and maintain proper width alignment of the endless track belt relative to the direction of travel to avoid de-tracking. It is understood that in some configurations, idler wheels can be considered and act as mid-roller wheels.

In this embodiment, the track system 20 includes three mid-roller wheel assemblies, but it is contemplated that the track system 20 could include more or less than three mid-roller wheel assemblies. Each of the leading and trailing idler wheel assemblies 60a, 60b and the mid-roller wheel assemblies 100a, 100b, 100c includes two laterally spaced wheels. The two laterally spaced wheels are also referred to herein as left and right wheels. It is contemplated that in some embodiments, at least one of the leading and trailing idler wheel assemblies 60a, 60b, and the mid-roller wheel assemblies 100a, 100b, 100c could have a single wheel, or three or more laterally spaced wheels.

In the depicted embodiment, the leading idler wheel assembly 60a is at least indirectly rotationally connected to a leading end of the lower frame member 56, the trailing idler wheel assembly 60b is at least indirectly rotationally connected to a trailing end of the lower frame member 56, and the mid-roller wheel assemblies 100a, 100b, 100c are at least indirectly rotationally connected to the lower frame member 56 longitudinally between the leading and trailing idler wheel assemblies 60a, 60b. As mentioned above, in some cases, at least one of the leading and trailing idler wheel assemblies 60a, 60b can be operatively connected to a tensioning assembly (not shown) connected to the frame 50 and configured to adjust and/or maintain a tension in the endless track 70 by moving a given one or both of the leading and trailing idler wheel assemblies 60a, 60b toward or away from the frame 50. More specifically, the tensioning assembly comprises a tensioning mechanism (not shown) that biases the leading and/or trailing idler wheel assemblies 60a, 60b away from the frame 50 in order to obtain and/or maintain a predetermined tension in the endless track 70.

The leading and trailing idler wheel assemblies 60a, 60b and the leading, intermediate and trailing support wheel assemblies 100a, 100b, 100c are positioned to have particular vertical positions relative to one another. In the illustrated embodiment, the leading and trailing idler wheel assemblies 60a, 60b are disposed vertically higher than the leading, intermediate and trailing support wheel assemblies 100a, 100b, 100c. That is to say that the rotational axis of the leading idler wheel assembly 60a and the rotational axis of the trailing idler wheel assembly 60b are vertically higher than the rotational axis of any one of the leading, intermediate and trailing support wheel assemblies 100a, 100b, 100c. Additionally, the leading support wheel assembly 100a is disposed vertically higher than the intermediate and trailing support wheel assemblies 100b, 100c, which are generally level with one another. That is to say that the rotational axis of the leading support wheel assembly 100a is vertically higher than the rotational axis of any one of the intermediate and trailing support wheel assemblies 100b, 100c.

The elevation of the leading idler wheel assembly 60a, and the support wheel 100a can, in some instances, assist the track system 20 in overcoming obstacles (i.e., increase approach angle) and/or help the track system 20 to steer (when the track system 20 is a steering track system). The same applies for the elevation of the trailing idler wheel assembly 60b as well (i.e., increase departure angle). In some embodiments, the leading idler wheel assembly 60a and/or the trailing idler wheel assembly 60b could bear weight, and thus could be considered to be support wheel assemblies.

As noted above, for various field applications, the track supporting wheel assemblies, namely, the idler wheel assemblies 60a, 60b and/or the mid-roller wheel assemblies 100a, 100b, 100c comprise at least one wheel having non-pneumatic, deformable radially-resilient tire materials comprising, for example, elastomeric or polymeric compounds. The use of non-pneumatic, deformable tires offers certain advantages over pneumatic wheels and/or rigid wheels in such field applications, such as, for example, no need to maintain tire inflation pressures, no issues with tire punctures, shock absorption, better ride-quality, vibration reduction, etc.

However, even with these advantages, traveling over large obstacles or uneven surfaces, these non-pneumatic deformable support wheels may be susceptible to severe compression levels and shearing forces that result in the outer tire surfaces of the support wheels bulging, side-shifting, or bottoming out. And, continued travel of such support wheels in these bulging, side-shifting or bottom-out states may result in width misalignment or de-tracking of the endless track belt, cause the bulging tire portions to contact and wear down drive lugs, contribute to premature wear of related components, etc.

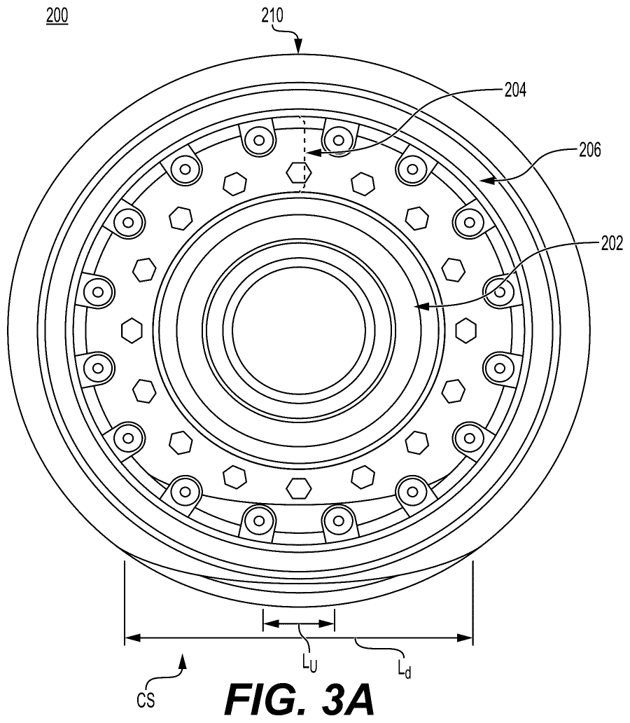

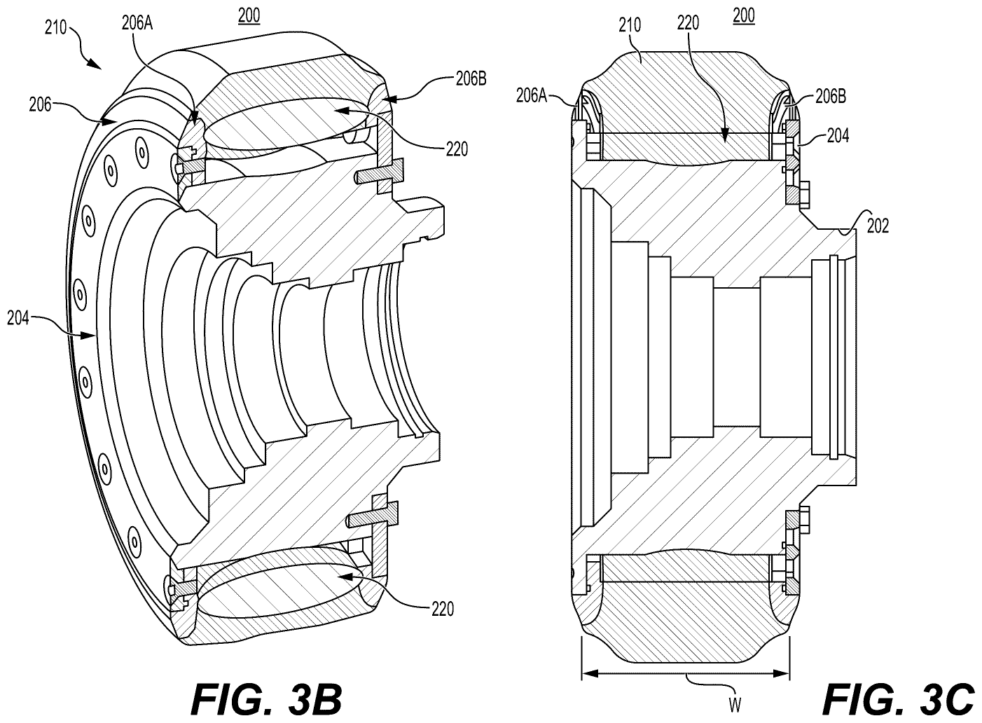

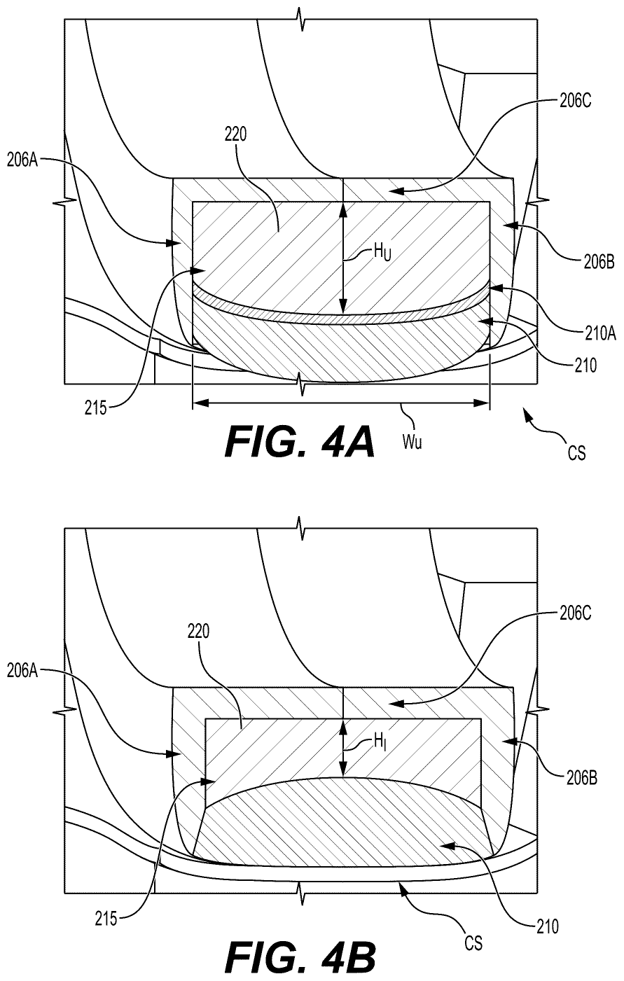

To this end, FIGS. 3A, 3B, and 3C, illustrate a deformable support wheel 200 with a resilient chamber 220, in accordance with the embodiments of the present technology. As will be described below, the resilient chamber 220 is deformable such that a shape and size thereof varies in response to the deformable support wheel 200 deforming. The deformable support wheel 200 includes a wheel central hub aperture portion 202, a wheel sidewall portion 204, a wheel rim 206, a deformable non-pneumatic tire portion 210, and a resilient chamber 220.

As depicted by FIG. 3A, the wheel central hub aperture portion 202 of the deformable support wheel 200 is structured to define an opening aperture for receiving and operatively connecting with a corresponding support axle (not shown) that extends outwardly in the axial direction. It is understood that the rotational configuration of the wheel 200 relative to the frame 50 can vary as known in the art. For example, the wheel 200 and the support axle can be immobile relative to each other and the support axle can be configured to be rotatable relative to the frame 50, or the support axle can be immobile relative to the frame 50 and the wheel 200 can be configured to be rotatable relative to the support axle. Required hardware (e.g., bearings, seals, fasteners, etc.) to ensure rotational connection of the wheel 200 relative to the frame 50 are hidden for sake of clarity. The wheel sidewall portion 204 is securely mounted and concentrically positioned to surround the outer circumference of the central hub aperture portion 202 and serves to provide supportive tensile strength to the deformable support wheel 200. In some embodiments, there could be two separate wheel sidewall portions 204. Different embodiments of the sidewheel portions 204 are described in U.S. Provisional Patent Application No. 63/420,276, filed Oct. 28, 2022 entitled “Resilient Wheel With Low-Friction and Wear Resistant Sidewall and Track System Having Same”, which is incorporated by reference herein in its entirety. In turn, the wheel rim portion 206 is securely mounted and concentrically positioned to surround the outer circumference of the wheel sidewall portion 204 and is configured with radially-extending vertical flanges 206A, 206B on respective outer and inner sides of support wheel 200 to receive and accommodate the secure mounting of the deformable non-pneumatic tire portion 210.

The non-pneumatic tire portion 210 thus extends radially outwardly from the wheel rim portion 206. The non-pneumatic tire portion 210 has a width W. As will be described below, the width W stays generally constant as the non-pneumatic tire portion 210 deforms. The non-pneumatic tire portion 210 further has a contact surface CS that is configured to interface with the inner surface 72 of the endless track belt 70. The contact surface CS manifests a contact length L. As will be described below, the contact length L can vary in shape and size in response to the deformable tire portion 210 deforming from an undeformed state to a deformed state.

It will be appreciated that the deformable non-pneumatic tire portion 210 may be made of resilient materials, such as, for example, elastomeric or polymeric compounds that accommodate different levels of compressional states by accordingly providing gradient levels of resilience. That is, based on these material compounds, as the tire portion 210 experiences different levels of compression, the resiliency of the tire portion 210 changes, such that, in the undeformed state, the deformable tire portion 210 provides a first radial resiliency while in a completely deformed state, the deformable tire portion 210 provides a second radial resiliency that is different from the first radial resiliency. As will be described in greater detail below, the radial resiliency of the deformable tire portion 210 can also be modulated by other factors, such as how the deformable tire portion 210 is confined between the side portions 204, a shape of the deformable tire portion 210, a thickness of the deformable tire portion 210 and/or a hardness of the deformable tire portion 210.

While the embodiment illustrated by FIG. 3A discloses the implementation of distinct structural portions or components of the deformable support wheel 200 assembled together, namely, the wheel central hub aperture portion 202, the wheel sidewall portion 204, wheel rim portion 206, and the deformable tire portion 210 to facilitate maintenance actions (e.g. installation, uninstallation, replacement, etc.) for instance, it will be appreciated that some these structural components may be embodied as a single or integral unit without departing from the scope of the present technology, via molding, over-molding, machining, 3D printing, and/or gluing processes for instance.

FIGS. 3B and 3C illustrate cross-sectional views of the deformable support wheel 200 with the resilient chamber 220, in accordance with the embodiments of the present technology. As shown, the resilient chamber 220 is in part defined by the configuration of the wheel rim portion 206.

In particular, as noted above, the wheel rim portion 206 is configured with radially-extending vertical flanges 206A, 206B on outer and inner sides of deformable support wheel 200 to accommodate the secure mounting of the deformable tire portion 210. In conventional applications, the secure mounting of a tire portion to a wheel rim portion comprises a tight, rigid attachment of the tire portion onto the outer peripheral surface of the wheel rim portion, with no gaps therebetween.

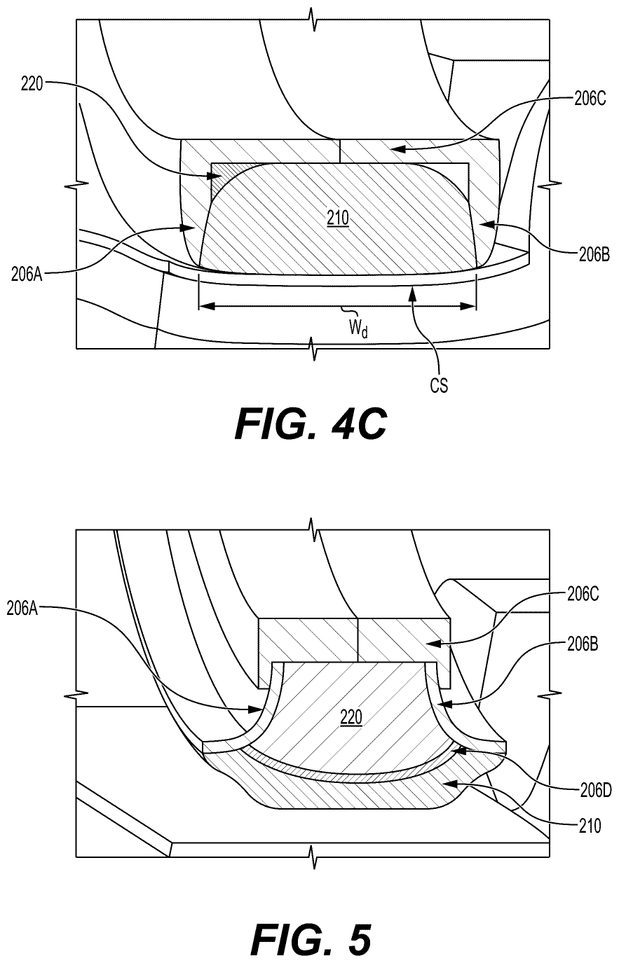

With this said, FIGS. 4A, 4B, and 4C, illustrate cross-sectional views of resilient chamber configurations 220, in accordance with the embodiments of the present technology. In FIG. 4A, the deformable tire portion 210 is in the undeformed state. In FIG. 4B, the deformable tire portion 210 is an intermediate deformed state. In FIG. 4C, the deformable tire portion 210 is in a fully deformed state.

As depicted by FIG. 4A, the wheel rim portion 206 is configured with an inner surface 206C and the radially-extending vertical flanges 206A, 206B. The radially-extending vertical flanges 206A, 206B flank the outer and inner sides of support wheel 200. It is contemplated that in some embodiments, the inner surface 206C could be defined by the central hub portion 202. It can be said that a gap 215 is defined between the inner surface 206C of the wheel rim portion 206 and a radially inner surface 210A of the deformable tire portion 210. It can be said that the gap 215 corresponds to the resilient chamber 220. As shown, in some embodiments, the inner surface 206C, the radially-extending vertical flanges 206A, 206B, and the radially inner surface 210A define the metes and bounds of the resilient chamber 220. It can be said that in some embodiments, the deformable tire portion 210 is at least partially confined by the radially-extending vertical flanges 206A, 206B. In particular, the structure of resilient chamber 220 defines boundaries that control and confine lateral deformations (e.g., bulging, side shifting, or bottoming out) of the non-pneumatic tire portion 210. As such, the resilient chamber 220 operates to minimize such lateral deformations during travel over large obstacles/uneven surfaces by redirecting the compression/shearing forces radially inward towards the resilient chamber 220. By virtue of the deformation control provided by the structure of resilient chamber 220, the deformable tire portion 210 does not substantially extend or bulge laterally beyond the vertical flanges 206A, 206B and does not substantially extend or bulge longitudinally beyond the nominal diameter of the tire portion 210 in an undeformed state.

In the undeformed state, the resilient chamber 220 has a radial height Hu. It will be noted that due to the radially inner surface 210A being concave, the radial height Hu varies along a width of the resilient chamber 220. In some embodiments, the radial height Hu is taken at a lateral center point of the resilient chamber 220. In the undeformed state, the deformable tire portion 210 has an undeformed radial resiliency.

In FIG. 4B, the deformable tire portion 210 has partially deformed such that it is in an intermediate deformed state. As mentioned above, the deformation of the deformable tire portion 210 is guided into the resilient chamber 220. The resilient chamber 220 has a radial height Hi. The radial height Hi is smaller than the radial height Hu. In this state, the deformable tire portion 210 has an intermediate radial resiliency. The intermediate radial resiliency is such that it is more difficult to deform the deformable tire portion 210 in this state than in the undeformed state. Thus, it can be said that there is a radial resiliency gradient, with the radial resiliency increasing as the radial height decreases.

In FIG. 4C, the deformable tire portion 210 is in the fully deformed state in which the deformable support wheel 200 experiences compression/shearing forces due to obstacles and/or uneven surfaces. As shown, instead of the deformable tire portion 210 laterally bulging, side-shifting, or bottoming out, the deformable support wheel 200 configuration enables the deformable tire portion 210 to redirect the compression forces radially inward towards the resilient chamber 220 (i.e., towards the gap 215) and accommodate the deformation of the footprint of the tire portion 210. Additionally, in this state, the gap 215 defined between the inner surface 206C and the radially inner surface 210A is null. Thus, the radial height is zero. It can be said that the width W of the deformable support wheel 200 is substantially unchanged before or during deformation. While in this state, the deformable tire portion 210 has a deformed radial resiliency that is different from the undeformed radial resiliency and the intermediate radial resiliency. The deformed radial resiliency is such that it is more difficult to deform the deformable tire portion 210 in the fully deformed state than in the undeformed and intermediate states. In some embodiments, in this state, the tire portion 210 could effectively no longer be deformable.

In the undeformed state, the contact surface CS of the deformable tire portion 210 has a length Lu. In some embodiments, the width W is greater than the length Lu.

In the deformed state, the contact surface CS of the deformable tire portion 210 has a length Ld. In some embodiments, the width W is smaller than the length Ld. The length Lu is smaller than the length Ld.

The width W in the undeformed state is generally to the width W in the deformed state due to the configuration of the deformable tire portion 210 and the presence of the resilient chamber 220.

The depicted configuration of the radially-extending vertical flanges 206A, 206B that contribute to defining resilient chamber 220 indicate a straight, linear profile shape. However, it should be appreciated that alternative profile shapes for the vertical flanges 206A, 206B are contemplated and considered. For example, FIG. 5 illustrates one such alternative configuration, in which the radially-extending vertical flanges 206A, 206B are configured to be inwardly curved. Other contemplated and considered alternative profile shapes for the vertical flanges 206A, 206B include inwardly/outwardly slanted configurations and outwardly-curved configurations.

It is further contemplated that in some implementations, the resilient chamber 220 may incorporate an access device (not shown), such as, for example, self-contained valve stem, configured to enable the increase, decrease, or adjustment of the volume of air/gas within the space defined by the inner surface 206C, radially-extending vertical flanges 206A, 206B, and the radially inner surface 210A.

In this manner, the presented deformable support wheel configuration for track-based vehicles is effectively capable of minimizing lateral deformations caused by compression/shearing forces experienced during challenging environmental conditions by controllably redirecting such deformations radially inward towards a resilient chamber provided by the deformable support wheel configuration.

All references cited in this specification, and their references, are incorporated by reference herein in their entirety where appropriate for teachings of additional or alternative details, features, and/or technical background.

While the disclosure has been particularly shown and described with reference to particular embodiments, it will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A wheel for a vehicular track-based system, comprising:
a central hub aperture portion configured to receive and operatively connect to a corresponding axle;
a sidewall portion configured to concentrically surround an outer peripheral surface of the central hub aperture portion, the sidewall portion comprising a pair of radially-extending flanges that are laterally spaced apart from each other;
a deformable tire portion concentrically mounted on the sidewall portion, wherein an inner surface of the flanges and an outer peripheral surface of the sidewall portion define a resilient chamber that provides a spacing between the outer peripheral surface of the sidewall portion and an inner peripheral surface of the tire portion.

2. The wheel of claim 1, wherein the resilient chamber controllably directs a deformation of the tire portion radially inward towards the spacing of the resilient chamber.

3. The wheel of claim 1, wherein at least one of the outer peripheral surface of the sidewall portion and an inner peripheral surface of the tire portion defines at least one boundary of the chamber that has a concave shape.

4. The wheel of claim 1, wherein the deformable tire portion comprises a non-pneumatic tire made of a resilient material.

5. The wheel of claim 1, wherein the radially-extending flanges have a straight linear profile.

6. The wheel of claim 1, wherein the radially-extending flanges have an inwardly curved profile.

7. The wheel of claim 1, wherein the radially-extending flanges have an outwardly curved profile.

8. The wheel of claim 1, wherein the radially-extending flanges have an inwardly slanted profile.

9. The wheel of claim 1, wherein the radially-extending flanges have an outwardly slanted profile.

10. The wheel of claim 1, wherein the central hub aperture portion and sidewall portion are integrally formed.

11. The wheel of claim 1, wherein the resilient chamber further comprises an access device configured to increase, decrease, or adjust a volume of fluid within the space defined by the chamber.

12. The wheel of claim 1, wherein:
the deformable tire portion has a width, and a contact surface interfacing with an inner surface of an endless track, in which the contact surface has a contact length,
with the deformable tire portion in an undeformed state, the contact length is smaller than the width, and
with the deformable tire portion in a deformed state, the contact length increases to be greater than the width.

13. The wheel of claim 1, wherein the spacing varies from a first radial dimension when the deformable tire portion is in the undeformed state to a second radial dimension when the deformable tire portion is in the deformed state, in which the second radial dimension is smaller than the first radial dimension.

14. The wheel of claim 13, wherein the second radial dimension is null when the deformable tire portion is fully compressed.

15. The wheel of claim 1, wherein the wheel has a width defining an undeformed lateral footprint when the deformable tire portion is in an undeformed state and a deformed lateral footprint when the deformable tire portion is in a deformed state, the deformed lateral footprint being equal to the undeformed lateral footprint.

16. The wheel of claim 1, wherein at least one of the hub peripheral surface, the inner surface of the radially-extending flanges, and an inner surface of the deformable tire portion has a concave profile.

17. The wheel of claim 4, wherein the resilient material of the non-pneumatic tire provides different gradient levels of resiliency to accommodate various degrees of compressional states such that in an undeformed state, the tire portion provides a first level of radial resiliency while in a completely deformed state, the tire portion provides a second level radial resiliency that is greater than the first radial level of resiliency.

18. The wheel of claim 1, wherein in response to deformable tire portion deforming, the radially-extending flanges are configured to confine and prevent lateral deformation of the deformable tire portion.

19. A track system for a track-based vehicle, comprising:
a drive wheel assembly configured to provide a driving force;
an endless track belt, operatively coupled to the drive wheel assembly, configured to actuate vehicle movement in accordance with the driving force; and
a wheel as defined in claim 1 engagedly supporting the endless track belt.

20. A vehicle comprising:
a frame;
a motor supported by the frame; and
the track systems as defined in claim 19 operatively connected to the motor.
